(19) United States
(12) Patent Application Publication
(10) Pub. No.: US 2006/0097517 A1
(43) Pub. Date: May 11, 2006

(54) Hose connector

(76) Inventor: Chao-Chang Wu, Taichung City (TW)

Correspondence Address: BACON & THOMAS, PLLC, 625 SLATERS LANE, FOURTH FLOOR, ALEXANDRIA, VA, 22314, US

(21) Appl. No.: 10/981,519

(22) Filed: Nov. 5, 2004

(51) Int. Cl. F16L 37/00

(52) U.S. Cl. 285/305

(57) ABSTRACT

A connector, which connects a hose to a nozzle, has a barrel with a tapered first hole and a second hole. The hose has a head received in the second hole of the barrel. A separator is received in the first hole of the barrel to be positioned at half of the first hole to keep a space under the separator. An inter-connector is received in the barrel with opposite ends inserted into the head of the hose and the separator respectively. The inter-connector has a flange received in the space of the barrel for free rotation. A pad is received in the first hole of the barrel and the nozzle is screwed into the first hole of the barrel and pressing the pad.

### BACKGROUND OF THE INVENTION

1. Field of the Invention

The present invention relates generally to a connector, and more particularly to a hose connector, which connects the nozzle to the hose and allows the nozzle free for rotation relative to the hose.

2. Description of the Related Art

FIG. 1 shows a connectional sprayer, which has a hose 50, a connector 52 mounted on an end of the hose 50 and a nozzle 54 detachably connected to the connector 52. The connector 52 has a barrel 56 with a two-order hole 58, an inter-connector 60 and an O ring 62. The hose 50 has a head 64 to be received in the hole 58 of the barrel 56. The head 64 has a flange 66 against an annular flat 68 on a sidewall of the hole 58 of the barrel 56. A rubber ring 70 is mounted in the head 64. The inter-connector 60 has a flange 72 on an end thereof against the flange 66 of the head 64 of the hose 50. The inter-connector 60 has teeth 74 on a circumference thereof and is inserted into the rubber ring 70 in an interference fit for leakage-proof. The O ring 62 is put in the hole 58 of the barrel 56 and against the flange 72 of the inter-connector 60. The nozzle 54 is screwed into the barrel 56 and presses the O ring 62. In this condition, the flanges 66 and 72 of the inter-connector 60 and the head 64 of the hose 50 are pressed by the nozzle 54 as well via the O ring 62, such that the head 64 and the hose 50 can not rotate. That is inconvenient to user.

### SUMMARY OF THE INVENTION

The primary objective of the present invention is to provide a hose connector, which allows the nozzle rotated relative to the hose.

According to the objective of the present invention, a connector, which connects a hose to a nozzle, comprises a barrel having a first hole and a second hole. The holes are open at opposite ends of the barrel and communicated with each other. The first hole has an exterior end at the end of the barrel and an interior end connected to the second hole and the hose has an end received in the second hole of the barrel. A separator is received in the first hole of the barrel and positioned at a position where between the interior end and the exterior end of the first hole. A space is left in the first hole between the interior end and the separator. An inter-connector is received in the barrel with an end thereof connected to the hose. The inter-connector has a flange received in the space of the barrel for free rotation.

### BRIEF DESCRIPTION OF THE DRAWINGS

FIG. 1 is a sectional view of the conventional hose connector;

FIG. 2 is an exploded view of a preferred embodiment of the present invention, and

FIG. 3 is a sectional view of the preferred embodiment of the present invention.

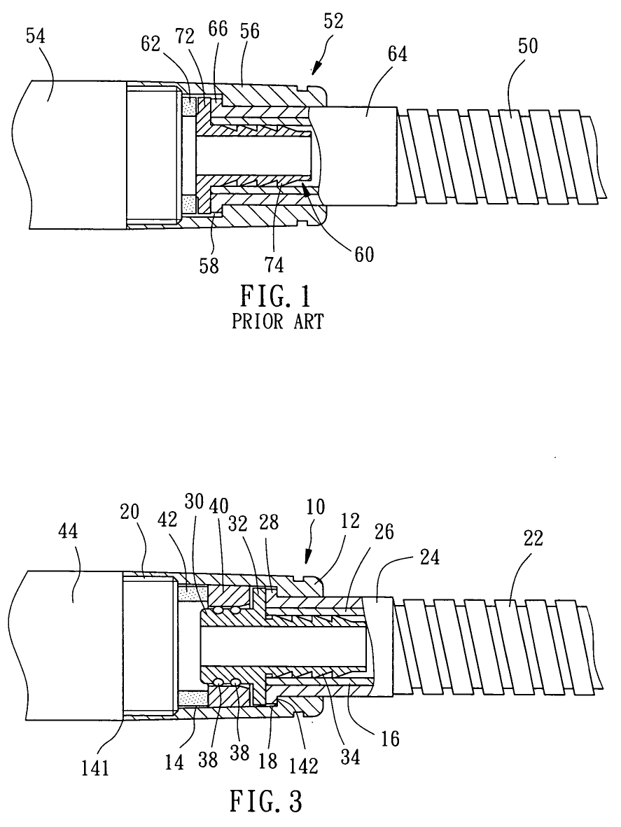

### DETAILED DESCRIPTION OF THE INVENTION

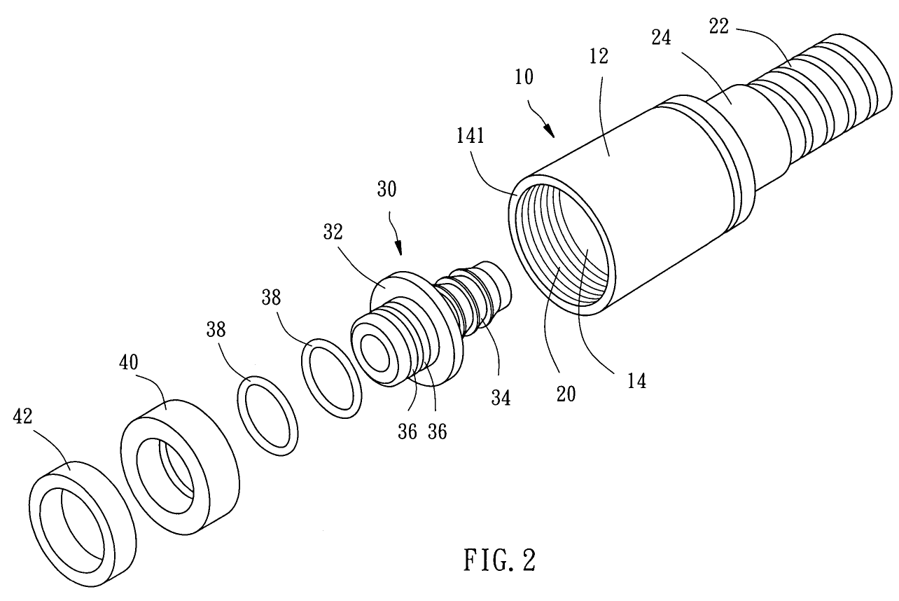

As shown in FIG. 2 and FIG. 3, a connector 10 of the preferred embodiment of the present invention, which connects a hose 22 to a nozzle 44, comprises:

A barrel 12 has a two-order hole, namely a first hole 14 and a second hole 16, and a stop flat 18 between the first hole 14 and the second hole 16. The first hole 14 is tapered, which is wide at an exterior end 141 thereof and is narrow at an interior end 142 thereof. A thread 20 is provided at the sidewall adjacent to the exterior end 141. The hose 22, which is similar to the conventional one, has a head 24 on an end thereof and a rubber ring 26 in the head 24. The head 24 is received in the second hole 16 of the barrel 12 and against the stop flat 18 with a flange 28.

An inter-connector 30 has a flange 32, teeth 34 and two slots 36 on a circumference thereof, wherein the flange 32 is located between the slot 36 and the teeth 34. Two O rings 38 are mounted in the slots 36 respectively. The inter-connector 30 is received in the barrel 12 with the flange 32 lying on the flange 28 of the head 24 of the hose 22.

A separator 40, which is a ring and made of a rigid material, is received in the first hole 14 of the barrel 12. An outer diameter of the separator 40 is less than the exterior end 141 of first hole 14 and is greater than the interior end 142 of the first hole 14, so that the separator 40 is stopped at a position between the exterior end 141 and the interior end 142 of the first hole 14. As a result, there is a space 143 left in the first hole 142 of the barrel 12 between the interior end 142 of the first hole 14 and the separator 40, in which the flange 32 of the inter-connector 30 is received. The inter-connector 30 has a portion inserted into the separator 40 with the O rings 38 pressing an interior wall of the separator 40 for leakage-proof.

A pad 42 is received in the first hole 14 of the barrel 12 between the exterior end 141 and the separator 40. The nozzle 44 is screwed into the first hole 14 of the barrel 12, meshed with the thread 20 and pressed on the pad 42.

The main character of the present invention is the separator positioned at a middle section of the first hole of the barrel to keep the space between the interior end of the first hole and the separator. The flange of the head of the hose is received in the space without any restriction, so that the head and the hose are free for rotation.

The present invention only introduces a way of positioning the separator in a half of the first hole of the barrel. In practice, there are many ways to achieve that, such as provide a protrusion on the sidewall of the first hole or provide the first hole of two orders, which an interior order thereof is smaller than an exterior thereof and so on.

What is claimed is:

1. A connector, which connects a hose to a nozzle, comprising:
a barrel having a first hole and a second hole, which the holes are open at opposite ends of the barrel and communicated with each other, wherein the first hole has an exterior end at the end of the barrel and an interior end connected to the second hole and the hose has an end received in the second hole of the barrel;
a separator received in the first hole of the barrel and positioned at a position where between the interior end and the exterior end of the first hole, so that a space is left in the first hole between the interior end and the separator, and
an inter-connector received in the barrel, which has an end connected to the hose and has a flange received in the space of the barrel for free rotation.

2. The hose connector as defined in claim 1, wherein the first hole of the barrel is tapered, which a diameter of the exterior end thereof is greater than the interior end thereof, and an outer diameter of the separator is smaller than the exterior end of the first hole and is greater than the second end of the first hole.

3. The connector as defined in claim 1, wherein the inter-connector has an end inserted into the separator.

4. The connector as defined in claim 3, wherein the inter-connector is provided with an O ring pressing the separator.

5. The connector as defined in claim 1, further comprising a pad received in the first hole of the barrel between the separator and the exterior end of the first hole.
